(19) United States
(12) Patent Application Publication
(10) Pub. No.: US 2007/0063377 A1
(43) Pub. Date: Mar. 22, 2007

(54) Method for the manufacture of monofilaments, as well as an artificial field

(75) Inventors: Gustaaf Hendrik Schoukens, Leuven (BE); Peter Van Reijen, NK Uden (NL)

Correspondence Address: OBLON, SPIVAK, MCCLELLAND, MAIER & NEUSTADT, P.C., 1940 DUKE STREET, ALEXANDRIA, VA, 22314, US

(73) Assignee: TAPIJTFABRIEK H. DESSEAUX N.V., AC Oss (NL)

(21) Appl. No.: 11/454,930

(22) Filed: Jun. 19, 2006

(30) Foreign Application Priority Data
Jun. 17, 2005 (NL) 1029276

(51) Int. Cl. B29C 47/88

(52) U.S. Cl. 264/211.12

(57) ABSTRACT

The present invention relates to a method for forming monofilaments, wherein a granular plastic material is fed to an extruder, whereupon the extruder screw pressurises the grains and presses them through the extruder head, after which the material thus obtained is subjected to a post-stretching operation. The present invention furthermore relates to monofilaments obtained by using such a method, as well as to an artificial lawn built up of the aforesaid monofilaments.

The present invention relates to a method for forming monofilaments, wherein a granular plastic material is fed to an extruder, whereupon the extruder screw pressurises the grains and presses them through the extruder head, after which the material thus obtained is subjected to a post-stretching operation. The present invention furthermore relates to monofilaments obtained by using such a method, as well as to an artificial lawn built up of the aforesaid monofilaments.

U.S. patent application US 2004/0032049 discloses a method comprising an extruder, wherein the extruded continuous yarns are fed through a tube and subsequently through a perforated tube, being the first cooling zone, after which a so-called mist chamber, being the second cooling zone, is used. Then the yarns are carried over rollers and blow-dried. The so-called pre-stretching operation is carried out by three rollers and a steam pipe at a ratio of 4.2, whereupon other rollers stretch the yarns further to a total proportion of 6.3.

U.S. Pat. No. 5,814,176 relates to a method for forming two monofilaments that are used in a lawn-mowing machine, which field of the art is not related to that of the present invention.

The production of monofilaments for use in artificial grass has traditionally taken place by carrying out a melting process in an extruder; the material is introduced into the feed hopper in granular form, after which a screw pressurizes the material—which heats up and melts in the meantime—and presses it through an extruder head.

The current production of monofilaments for use in artificial grass is inter alia based on post-stretching in solid condition at a controlled (elevated) temperature. This cold stretching generally leads to enhanced classical mechanical properties—stiffness and strength—as a result of an increased orientation of the individual polymer chains in the stretching direction. Cold-stretching sets up mechanical tensions in the material, however, which may express themselves at a later stage—in actual use—in the form of a reduced resilience (flattening of the grass after being played on repeatedly) and a reduced thermal resistance (flattening of the grass after being exposed to an elevated temperature). After all, frequent playing on the grass as well as elevated temperatures lead to the mechanical tensions being released from the material, resulting in a reduced stiffness and strength. In addition to the aforesaid deterioration of the mechanical properties with the passage of time, fibrillation—the splitting of the filaments in the longitudinal direction—is another problem that may occur when cold stretching is carried out: after all, only small intermolecular forces are possible between the strongly oriented polymer chains, and also the degree of entwinement—which provides mechanical cohesion in the transverse direction—is limited due to the high level of orientation. The resilience and the thermal resistance will improve when less mechanical tension is set up in the starting material (the monofilaments) during production.

The present invention is characterised in that the post-stretching operation is carried out during the melting phase of the plastic material.

Special embodiments are defined in the appended subclaims. The temperature after post-stretching ranges between the extrusion temperature and the crystallization temperature of the plastic. For HDPE, for example, such values are 200-250° C. and 130-135° C., respectively.

Stretching during the melting phase is a way of obtaining this result. In the case of melt stretching, the obtained monofilaments will be drawn from the extruder head at such a velocity that in addition to a significant reduction of the original cross-sectional area also a certain degree of orientation of the individual polymer chains is effected. It is preferable to select the granular plastic from the group consisting of polyamide, polyolefins, such as polypropylene, block copolymers of polypropylene and polyethylene, HDPE, MDPE, LDPE, LLDPE and anhydride modified polyethylene compounds.

It is desirable that the degree of post-stretching, i.e. the ratio between the cross-sectional area of the plastic mass exiting the extruder head prior to and after the stretching operation, is at least 2, in particular that the degree of post-stretching is maximally 20.

This orientation is significantly smaller than in the case of cold stretching, but as the phenomenon occurs during the melting phase, there is a greater chance of the mechanical tensions being released before the monofilament solidifies. Thus the result is a monofilament whose classical mechanical properties, such as the elasticity modulus, may be less favourable than those of cold-stretched monofilaments, but which—because the amount of mechanical tensions therein is lower and because the polymer crystallises after orientation—also has a lower potential for weakening caused by heat and being played on repeatedly. Because of the different degree of orientation that occurs in the case of melt stretching, the fibrillation tendency will be lower than in the case of cold-stretched filaments: after all, the intermolecular forces and the intertwinement will be greater because of the crystallisation following orientation. Preferably, the extrusion process is carried out in such a manner that the monofilaments are given a trilobal shape.

The present invention further relates to an artificial lawn built up from monofilaments obtained by using the present method.

In a special embodiment the degree of shrinkage is preferably less than 1.0%, measured at 100° C., the pushover energy is at least 50 micro Joules and the bending modulus (MPa) is at least 700.

The possible lack of stiffness can be readily offset by means of a relatively small increase of the cross-sectional area. It is also possible to use a more resilient geometry of the cross-section to offset the lower modulus of the obtained filament.

The present invention will now be explained in more detail by means of a number of examples, in which connection it should be noted, however, that the present invention is by no means limited to such special examples.

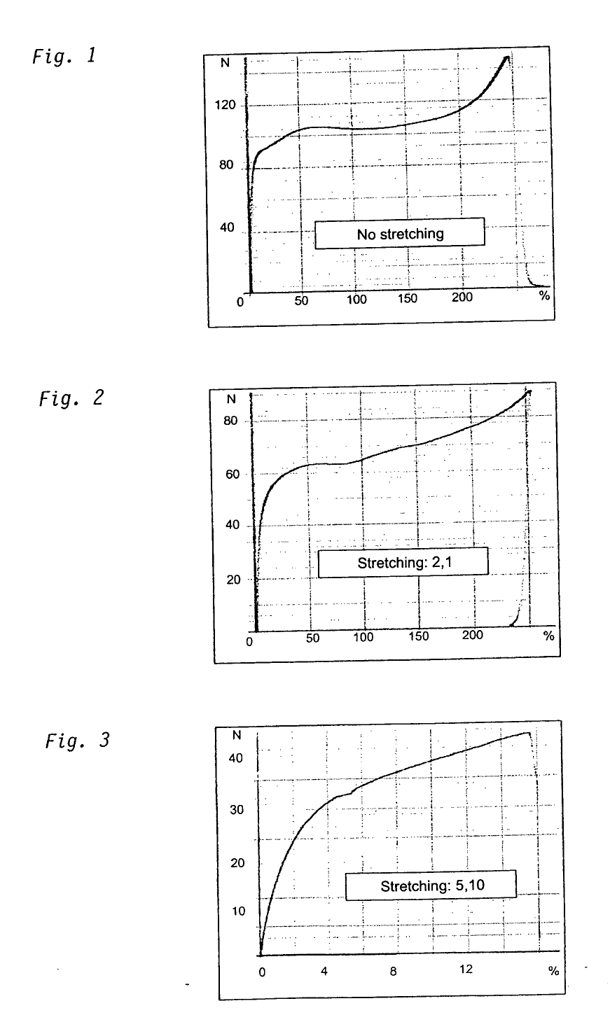

FIG. 1 is a force-elongation diagram of a situation in which no stretching took place.

FIG. 2 is a force-elongation diagram of a situation in which the degree of post-stretching in the melting phase was set at a value of 2.1.

FIG. 3 is a force-elongation diagram of the situation in which the degree of post-stretching in the melting phase was set at a value of 5.1.

### EXAMPLE

HDPE from Basell (Hostalen GF 7740 F3 having a MFR of 0.5 g/10 min at 190° C. at a load of 2.16 kg, according to ISO 1133) was extruded at an extruder head temperature of 250-260° C. and a spacing between the extruder head and the stretching rollers of about 7.5 cm.

The data below relating to extruded wide bands of the sample material HDPE illustrate the previously discussed advantages of melt stretching.

The trend of the elongation curve (see FIGS. 1-3) will change as the extent of stretching in the melting phase increases. The original constriction in the case of no stretching or moderate stretching will clearly decrease and even disappear when sufficient melt stretching takes place. Constriction (the maximum in the curves) is a phenomenon which can be clearly related to poor resilience. When constriction is avoided (in the case of sufficient melt stretching), no deformation will take place in the irreversible region of the constriction when bending of the monofilaments (upon being played on) takes place. In other words, the material—the monofilament—will spring back elastically to its original position.

The following table is a survey of the properties as a function of the melt stretching process:

| Stretching | E (MPa) | E_{f} (MPa) | RBB (%) | Fibrillation | Pushover-W | Shrinkage |
|---|---|---|---|---|---|---|
| 1 | 700 | 300 | 300 | N-B | 90 μJ | 1.7% |
| 2, 1 | 750 | 270 | 270 | B | 110 μJ | 0.1% |
| 5, 1 | 1350 | 18 | 18 | M | 240 μJ | 0.1% |

wherein:
Stretching: the degree of melt stretching (ratio beween cross-sectional areas before and after a melt stretching)
E: the elongation modulus
E_{f}: the bending modulus
RBB: stretch upon fracture
Fibrillation: categorised as follows
N: no fibrillation, not even after initiation of cracking by notching
B: no fibrillation without notching, very limited fibrillation after initiation of cracking by notching
M: no fibrillation without notching, moderate fibrillation after initiation of cracking by notching
Pushover-W: the energy required for completely pushing over an isolated monofilament having a thickness of 0.2 mm and a width of 1 mm (pile height 17.5 mm)
Shrinkage: the change in length in terms of percentage after 2 hours of exposure to 100° C., in other words, the thermal resistance; hardly any significant shrinkage occurred below 100° C.

These results clearly indicate that a sufficient degree of melt stretching (stretching between 2 and 5) for the tested HDPE has the following advantages:

distinct modulus increase,

disappearance of the constriction area (see curves) and thus an improved resilience,

reduced fibrillation, on condition that no extreme stretching (even at stretching values of 4 to 5 the extent of fibrillation was very limited),

an increased energy absorption as a result of the increased modulus—so that the ball will roll less, and

reduced shrinkage and thus a distinctly improved thermal resistance.

1. A method for forming monofilaments, wherein a granular plastic material is fed to an extruder, whereupon the extruder screw pressurises the grains and presses them through the extruder head, after which the material thus obtained is subjected to a post-stretching operation, characterised in that the post-stretching operation is carried out during the melting phase of the plastic material.

2. A method according to claim 1, characterised in that the degree of post-stretching, i.e. the ratio between the cross-sectional area of the plastic mass exiting the extruder head prior to and after the stretching operation, is at least 2.

3. A method according to claim 2, characterised in that the degree of post-stretching is maximally 20.

4. A method according to any one or more of the preceding claims, characterised in that the granular plastic is selected from the group consisting of polyamide, polyolefins, such as polypropylene, block copolymers of polypropylene and polyethylene, HDPE, MDPE, LDPE, LLDPE and anhydride modified polyethylene compounds.

5. A monofilament obtained by using a method according to any one or more of the preceding claims, characterised in that the degree of shrinkage is less than 1.0%, measured at 100° C.

6. A monofilament according to claim 5, characterised in that the pushover energy is at least 50 micro Joules.

7. A monofilament according to either one or both of the claims 5-6, characterised in that the bending modulus (MPa) is at least 700.

8. An artificial lawn built up from monofilaments according to any one or more of the claims 5-7.
